(19) United States
(12) Patent Application Publication
(10) Pub. No.: US 2013/0327831 A1
(43) Pub. Date: Dec. 12, 2013

(54) DYNAMIC IMAGER SWITCHING

(71) Applicant: Datalogic ADC, Inc., Eugene, OR (US)

(72) Inventor: Brett Thomas Howard, Eugene, OR (US)

(21) Appl. No.: 13/913,086

(22) Filed: Jun. 7, 2013

Related U.S. Application Data
(60) Provisional application No. 61/658,250, filed on Jun. 11, 2012.

(51) Int. Cl. G06K 7/10

(52) U.S. Cl. CPC G06K 7/1096
USPC 235/440

(57) ABSTRACT

An data reader is disclosed that includes an imager switch that couples a plurality of imagers to a single imager interface of a processor. The imager switch includes a plurality of imager interfaces to couple to a plurality of imagers, a processor interface to couple to an imager interface of a processing device, switching logic, and detection logic. The switching logic receives input from the plurality of imager interfaces and forwards data received at a presently selected imager interface to the processor interface. The detection logic detects that a desired set of image data (e.g., a complete image frame or a portion of an image frame) is received at the presently selected imager interface and automatically, dynamically, and/or intelligently changes the presently selected imager interface of the image data switching logic from a first imager interface to a second imager interface.

### RELATED APPLICATIONS

This application claims the benefit under 35 U.S.C. §119(e) of U.S. Provisional Patent Application No. 61/658,250, filed Jun. 11, 2012, and titled DYNAMIC IMAGER SWITCHING, which is hereby incorporated by reference herein in its entirety.

### BACKGROUND

The field of the present disclosure relates generally to systems, apparatus, and methods for data reading and/or image capture and more particularly to systems, apparatus, and methods to couple imaging devices to a processing device.

Data reading devices are used to read optical codes, acquire data, and capture a variety of images. Optical codes typically comprise a pattern of dark elements and light spaces. There are various types of optical codes, including one-dimensional codes, such as a Universal Product Code (“UPC”) and EAN/JAN codes, and stacked and two-dimensional codes, such as PDF417 and Maxicode codes.

Data reading devices are well known for reading UPC and other types of optical codes on items (or objects), particularly in retail stores. As an optical code is passed through a view volume of the data reading device, the optical code is scanned and read by the data reading device to create electrical signals. The electrical signals can be decoded into alphanumerical characters or other data that can be used as input to a data processing system, such as a point of sale (POS) terminal (e.g., an electronic cash register). The POS terminal can use the decoded data to, for example, look up a price for the item, apply electronic coupons, and award points for a retailer or other rewards program. Scanning an optical code on items may enable, for example, rapid totaling of the prices of multiple such items.

One common data reading device is an imaging reader that employs an imaging device or sensor array, such as a charge coupled device (CCD) or complementary metal oxide semiconductor (CMOS) device. The imaging device generates electronic image data, typically in digital form. The image data is then processed, for example, to find and decode an optical code. An imaging reader can be configured to read both 1-D and 2-D optical codes, as well as other types of optical codes or symbols and images of other items.

An imaging reader may be capable of scanning multiple sides of an item, for example, by utilizing a plurality of imagers. The plurality of imagers may be arranged in a bi-optic configuration that may include multiple (e.g., two) scanner windows. By way of example, and not limitation, an “L-shaped” bi-optic data reading device may include a horizontal bottom scanner that is generally positioned at counter level and a vertical scanner that is positioned to scan one or more sides of an item. By scanning one or more sides of an item, an imaging reader having a plurality of imagers may increase probability of a successful first scan (i.e., improved first pass read rate) and may reduce time-consuming product manipulations and repeat scans by operators.

The images captured by the imager(s) of an imaging reader are processed to identify and decode an optical code on an item passed through a view volume of the imaging reader. Generally a processing device is associated with each imager to provide processing of captured image data. A processing device may have a single imager interface and may only be capable of processing the output of a single imager at any given time. As a result, a plurality of processing devices may be needed in an imaging reader having a plurality of imagers and additional hardware and/or software may be needed to coordinate cooperation between the plurality of processing devices. Thus, the present inventors have recognized, among other things, the desirability to reduce complexity and hardware in a multi-imager data reading device.

### BRIEF DESCRIPTION OF THE DRAWINGS

Understanding that drawings depict only certain preferred embodiments and are therefore not to be considered limiting in nature, the preferred embodiments will be described and explained with additional specificity and detail through the use of the accompanying drawings.

FIG. 1 is a perspective view of a data reader, according to one embodiment.

FIG. 2 is a diagram of scan regions and imaging components of the data reader of FIG. 1.

FIG. 3 is a block diagram of a dynamic intelligent imager switch, according to one embodiment, coupled to a plurality of imagers and an image processing device.

FIG. 4 is a block diagram of a data reader, according to one embodiment.

FIG. 5 is an example timing diagram of dynamic intelligent imager switching, according to one embodiment.

FIG. 6 is an example timing diagram illustrating biasing in dynamic intelligent imager switching, according to one embodiment.

FIG. 7 is a flow diagram of a method of dynamic intelligent imager switching, according to one embodiment.

### DETAILED DESCRIPTION OF EMBODIMENTS

With reference to the drawings, this section describes particular embodiments and their detailed construction and operation. The embodiments described herein are set forth by way of illustration only and not limitation. The described features, structures, characteristics, and methods of operation may be combined in any suitable manner in one or more embodiments. In view of the disclosure herein, those skilled in the art will recognize that the various embodiments can be practiced without one or more of the specific details or with other methods, components, materials, or the like. In other instances, well-known structures, materials, or methods of operation are not shown or not described in detail to avoid obscuring more pertinent aspects of the embodiments.

Various dynamic intelligent imager switching systems, apparatus, and methods are described herein and can be utilized in various imager-based data readers, reading systems, and associated methods. Some embodiments of these data readers and systems may provide for improved or enhanced reading performance by providing multiple image fields to capture multiple views. In the following description of the figures and any example embodiments, it should be understood that any image fields or fields of view related to any imager may be partitioned into two or more regions, each of which may be used to capture a separate view or perspective of the view volume. In addition to providing more views than imagers, such embodiments may enhance the effective view volume beyond the view volume available to a single imager having a single field of view.

In the following description of the figures and any example embodiments, it should be understood that use of a data reader having the described features in a retail establishment is merely one use for such a system and should not be considered as limiting. By way of example, and not limitation, another use for data readers with the characteristics and features described herein may be in an industrial location such as a parcel distribution (e.g., postal) station.

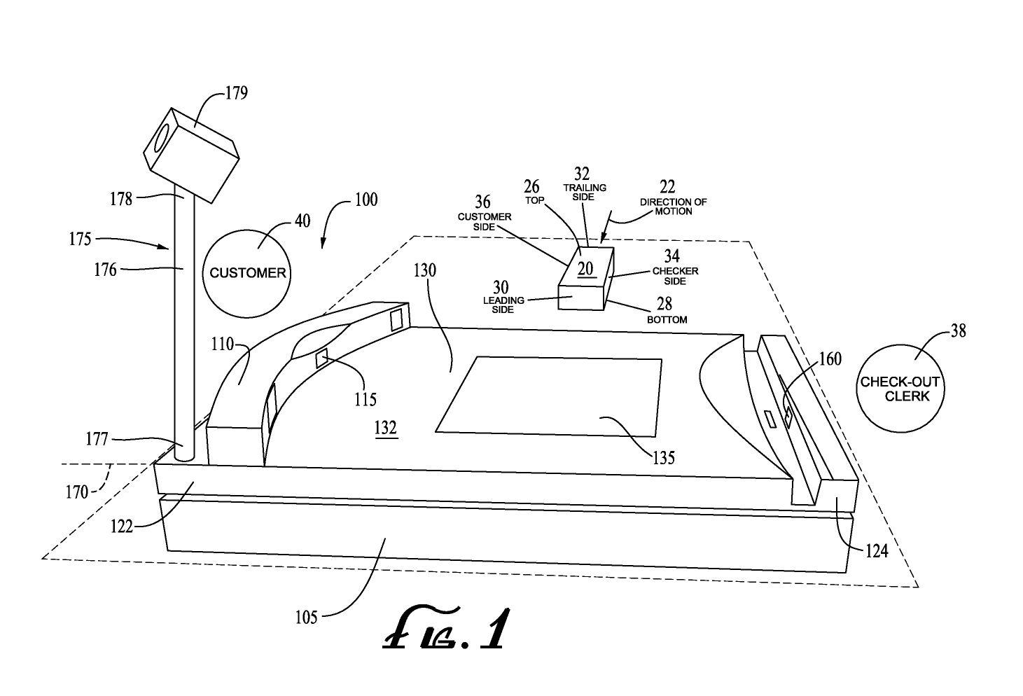

FIG. 1 illustrates a data reader 100 and an example of an item 20 that may be passed through a view volume of the data reader 100. For general purposes of discussion, the item 20 is represented as a six-sided, box-shaped object having a top surface 26, a bottom surface 28, a leading side 30, a trailing side 32, a checker side 34, and a customer side 36. In some instances, the item 20 may be described with respect to its direction of motion 22 across a generally horizontal surface 132 of a cover or platter 130. Although, the item 20 is shown and described as a box-shaped object for convenience, it should be understood that items 20 may be other shapes, including, for example, round cans or irregularly shaped objects, such as a bag of oranges, potato chips, or the like.

The data reader 100 may have a frame, which may include a lower housing section 105 and an upper cover or platter section 130. In some embodiments, a portion or all of the cover or platter section 130 may be a weigh platter operable for weighing the item 20. The illustrated data reader 100 is typically installed into a countertop or work surface 170 (indicated by dashed line) of a checkstand such that the horizontal surface 132 of the platter 130 is flush, or substantially level, with the countertop or work surface 170 of the checkstand.

Typical or example positions of an operator (e.g., a check-out clerk 38) and a customer 40 are shown to facilitate description and to establish a frame of reference, and are not intended to be limiting. The check-out clerk 38 may typically stand or sit adjacent to a checker side 124 of the data reader 100, and away from an opposing customer side 122 of the data reader 100. The check-out clerk 38 may move or transport the item 20 across the horizontal surface 132 in the direction of motion 22. Although the direction of motion in FIG. 1 is shown as right to left, objects may also be moved across the horizontal surface 132 in other directions (e.g., a left to right direction). The data reader 100 may be used without a check-out clerk 38 and that the customer 40 (or check-out clerk 38) may be positioned at any side of the data reader 100.

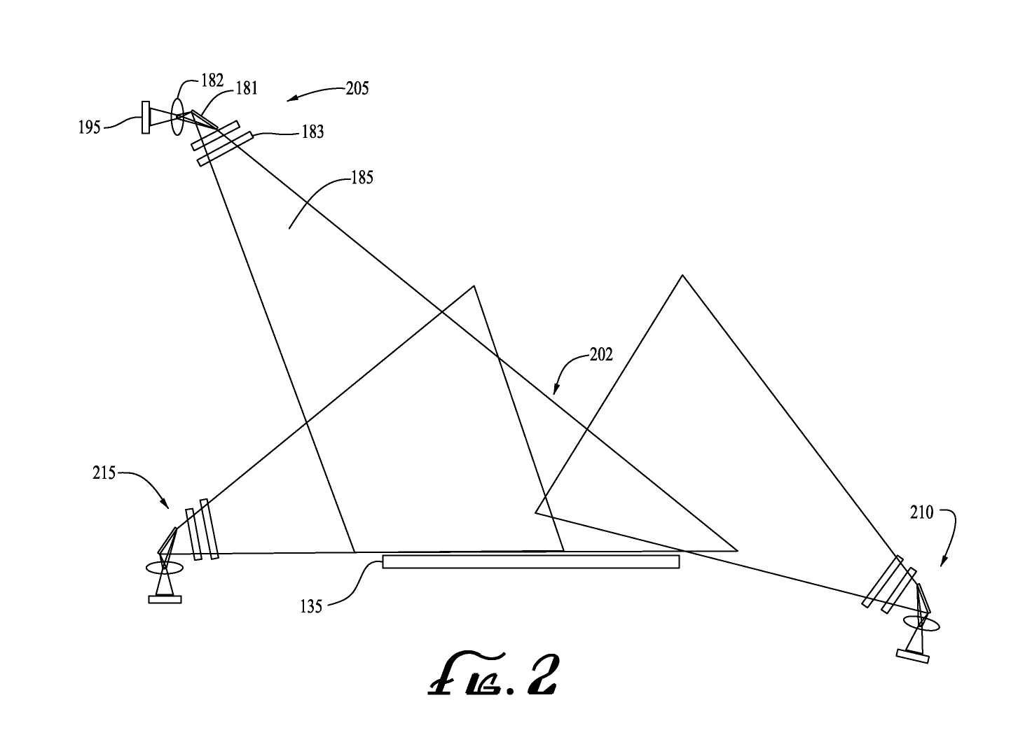

The data reader 100 may include one or more imagers (see FIG. 2) that may capture image data of items 20 being moved past the view regions of the imagers. The one or more imagers may be positioned behind the scan windows 115, 135, and 160 and the view region or field of view (FOV) of each imager may be directed through a corresponding scan window 115, 135, and 160 to a view volume (see FIG. 2). Because the customer side 122 of the data reader 100 is on the side away from the check-out clerk 38, a vertically-protruding section 110 may be provided, which may house an imager behind the window 115. Additional imagers may be provided at different positions along the vertical section 110. In other embodiments, the imagers may not be housed within the vertically-protruding section 110, but instead housed within the lower housing section 105 and operable to read through the window 115 by using one or more mirrors to direct the FOV of each imager through the window 115.

The imagers, such as the imager behind the window 115, may be operative to capture image data including optical codes on item surfaces facing away from the check-out clerk 38 (such as on the customer side 36 of the item 20), without interfering with the check-out clerk's 38 limbs as the item 20 is moved through the view volume. For capturing image data including optical codes disposed on the checker side 34 of the item 20, an imager may be positioned behind the window 160 with the imager's FOV directed across the platter 130 toward the customer side 122.

The data reader 100 may further include an upwardly extending post 175 extending along a vertical axis that may be generally transverse or even perpendicular in relation to the horizontal surface 132 of the platter 130. The post 175 may include a vertically elongated post body 176 having a first end 177 and an opposing second end 178. The post 175 may be mounted or otherwise secured to the platter 130 adjacent the first end 177 and may include a housing structure 179 supported adjacent the second end 178. The housing structure 179 may be sized and dimensioned to house an imager operable to capture a top-down view of the item 20. Additional details of the imager and its components are discussed below with reference to FIG. 2.

It should be understood that the described arrangements are meant only to illustrate example embodiments and other arrangements for the post 175 not specifically described herein may be possible.

FIG. 2 illustrates a diagram of imagers 205, 210, 215 and/or imaging system components of the data reader 100 of FIG. 1. The diagram of the data reader 100 shows the scan regions or field of view (FOV) of the imagers 205, 210, 215. Specifically, the FOV 185 of the imager 205 is shown. Most of the enclosure components are removed from the drawing to reveal an example of an interior optical arrangement of the imagers 205, 210, 215 and/or other imaging system components. For reference, the upper horizontal window 135 disposed in the platter 130 of FIG. 1 is included in FIG. 2.

Components of the imaging system are described with reference to a given imager 205. It should be understood that the other two imagers 210 and 215 may have substantially similar features and characteristics as those described with respect to imager 205. Accordingly, individual features of imaging systems 210 and 215 may be generally described herein.

With reference to FIG. 2, the imager 205 may comprise an image sensor or sensor array 195, a primary fold mirror 181, a lens system 182, and a window 183. The field of view 185 of the imager 205 is broad enough to overlap the surface area of the upper horizontal window 135, but preferably is much larger to cover a substantial portion of the platter 130 (see FIG. 1). The field of view 185 may define a portion of a view volume 202 of the data reader 100, together with the fields of view of the two other imagers 210, 215.

The imager 205, the imager 210, and the imager 215 may be arranged in a variety of configurations and, for purposes of the present disclosure, it should be understood that they are not limited to the positioning or functions described above. Rather, the diagram of FIG. 2 serves to illustrate one embodiment of a data reader 100 utilizing a plurality of imagers to capture image data of optical codes. The plurality of imagers of an imaging reader may also be arranged in other configurations. Non-limiting examples and additional description of data reading devices (e.g., scanners) utilizing a plurality of imagers to scan multiple sides of an item are provided in U.S.

Provisional Patent Application No. 61/657,634, entitled OPTICAL SCANNER WITH TOP DOWN READER, attorney docket no. 51306/1605, filed Jun. 8, 2012, U.S. patent application Ser. No. 13/895,258, entitled OPTICAL SCANNER WITH TOP DOWN READER, attorney docket no. 51306/1606, filed May 15, 2013, U.S. Provisional Patent Application No. 61/657,660, entitled IMAGING READER WITH IMPROVED ILLUMINATION SYSTEM, attorney docket no. 51306/1610, filed Jun. 8, 2012, and U.S. patent application Ser. No. 13/911,854, entitled IMAGING READER WITH IMPROVED ILLUMINATION SYSTEM, attorney docket no. 51306/1611, filed Jun. 6, 2013, each of which is hereby incorporated herein in its entirety.

The imager 205, the imager 210, and the imager 215 may capture image data that may be processed by a processing device to identify and/or decode optical codes. Typically, a processing device would be associated with each of the imagers 205, 210, 215, thus requiring three processing devices in the illustrated embodiment of FIGS. 1 and 2. The present inventors have recognized that an intelligent switch that couples a plurality of imagers to a single imager interface of a processing device and that dynamically switches the image data output of the plurality of imagers to the imager interface of the processor can reduce complexity and hardware in a multi-imager data reading device.

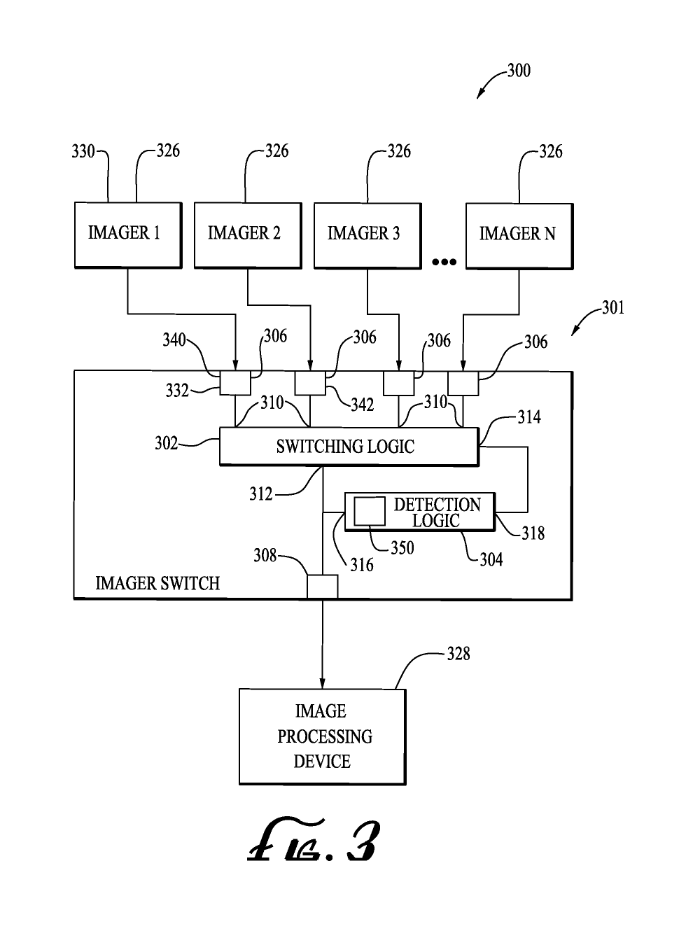

FIG. 3 is a block diagram of a data reading system 300, according to one embodiment, with multiple imagers 326, a dynamic intelligent imager switch 301, and a processor 328 (or image processing device). The dynamic intelligent imager switch 301 is shown coupled to a plurality of imagers 326 and a processing device 328, such as in a data reader (e.g., the data reader 100 of FIGS. 1 and 2). The dynamic intelligent imager switch 301 may include switching logic 302 and detection logic 304. The dynamic intelligent imager switch 301 may further include a plurality of imager interfaces 306 and a processor interface 308. The dynamic intelligent imager switch 301 may enable a single processing device 328, which may be configured to couple to only a single imager, to receive and process image data from each of the plurality of imagers 326. The dynamic intelligent imager switch 301 may receive data, including image data, from each of the plurality of imagers 326 and pass (or forward) the data from one of the plurality of imagers 326 to the processing device. Moreover, the dynamic intelligent imager switch 301 may perform the switching automatically. Manual switching or external input is not needed. The dynamic intelligent imager switch 301, when properly switching, may produce a clean and continuous stream of image data (composed of images captured by multiple imagers) that can be presented to the processing device 328 as if from a single imager 326. In this manner, a single basic processing device may be used in imaging reader applications (e.g., systems, scanners) utilizing a plurality of imagers.

The switching logic 302 of the dynamic intelligent imager switch 301 may be configured to receive data from the plurality of imagers 326 and select data from one of the plurality of imagers 326 to output (e.g., pass or forward) to the processor interface 308 and/or the processing device 328. Described differently, the switching logic 302 receives data at multiple inputs 310 and selects and forwards all or a portion of the data of only one of the inputs 310 at a single output 312. For example, the presently selected imager 330 may provide data that is received by the switching logic 302 at one of the multiple inputs 310 and the switching logic may forward all or a portion of that data to the output 312. The data received from the plurality of imagers 326 includes image data captured by the plurality of imagers 326. The switching logic 302 may also be configured to receive at the inputs 310 various other data, such as control data and/or configuration data that accompanies the image data from the plurality of imagers 326. For example, the control data and/or configuration data may include, but is not limited to, a clock, a clock rate, an exposure time, an exposure rate, a frame rate, a read-out time, a pixel clock, and the like. In another embodiment, the switching logic may also pass data (e.g., control data or configuration data) from the output 312 (e.g., from the processor interface 308 and/or processing device 328) back to the inputs 310 (e.g., to the plurality of imager interfaces 306 and/or the plurality of imagers 326).

As the data is received from the plurality of imagers 326 at the multiple inputs 310, a portion or set of the image data from a presently selected imager 330 (one of the plurality of imagers 326 that is coupled to a presently selected imager interface 306) may include a complete image frame containing substantially all the pixels captured by the presently selected imager 330. The complete image frame is passed, in the set of image data, to the output 312 of the switching logic 302 for forwarding to the detection logic 304 and/or the processor interface 308. In certain embodiments, a partial image frame, or other desired portion of an image frame or image data, may be passed to the output 312 of the switching logic 302 for forwarding to the detection logic 304 and/or the processor interface 308. The partial image frame may include desired image data (e.g., an optical code).

The single output 312 of the switching logic 302 may be coupled to the processor interface 308 and data passed to the output 312 of the switching logic 302 may be forwarded to the processor interface 308 and on to the processing device 328 coupled thereto. The data passed to the output 312 may include received image data, including a complete image frame (or another desired portion of an image frame). The data passed to the output 312 by the switching logic 302 may also include various control data and/or configuration data accompanying the image data. Accordingly, the detection logic 304 and/or the processor interface 308 may be able to receive and/or forward any of the image data, the control data, and/or the configuration data received from the presently selected imager 330.

The switching logic 302 selects which input 310 to forward to the output 312 based on a selection input 314 received from the detection logic 304. In other words, the switching logic 302 selects a presently selected imager interface 332, and therefore the presently selected imager 330, based on the selection input 314 received from the detection logic 304. As described more fully below, the detection logic 304 determines the selection input based on detection of a complete image frame (or other desired portion or expected portion of image data) being forwarded to the output 312 of the switching logic 302.

In one embodiment, the switching logic 302 may be a multiplexer configured to receive multiple inputs 310 and to select and pass (or forward) one of the inputs unchanged as an output 312. In another embodiment, the switching logic 302 may include hardware and/or circuitry configured to select one of multiple inputs 310 to forward all or a portion thereof as an output 312. In another embodiment, the switching logic 302 may include a combination of hardware and software components. In still another embodiment, the switching logic 302 may include embedded instructions. In still another embodiment, the switching logic 302 may include software modules. In still another embodiment, the switching logic 302 may include a demultiplexer configured to pass data back from the output 312 (e.g., from the processor interface 308) to the inputs 312 (e.g., to the plurality of imager interfaces 306).

The detection logic 304 is coupled to the switching logic 302 and may be configured to detect and determine an appropriate time to switch the presently selected imager interface from a given imager interface to a different imager interface. The detection logic 304 may receive all or at least a portion of the output 312 of the switching logic 302. The detection logic 304 may receive the output 312 of the switching logic 302 as an input 316 and detect, for example, when a complete image frame is passed to the processor interface 308 and/or the processing device 328. In other words, the detection logic 304 may detect when a complete image frame (e.g., all, or substantially all, the pixels of a complete image as captured by one of the plurality of imagers 326) has been forwarded to the processing device 328. In another embodiment, the detection logic 304 may be configured to detect a partial image frame or an expected amount of image data. For example, the detection logic 304 may detect a given number of pixels (e.g. an expected number of pixels), which may be a partial image frame.

Once an expected or desired portion of image data (e.g., a complete image frame, a partial image frame, a given number of pixels, etc.) is detected (and forwarded to the processor interface 308 and/or the processing device 328), the detection logic 304 may provide an output 318 that is communicated to the switching logic 302 to instruct or otherwise signal or indicate to the switching logic 302 which input 310 to select to pass (or forward) to the output 312. In other words, the output 318 of the detection logic 304 may be communicated to the switching logic 302 as the selection input 314 of the switching logic 302.

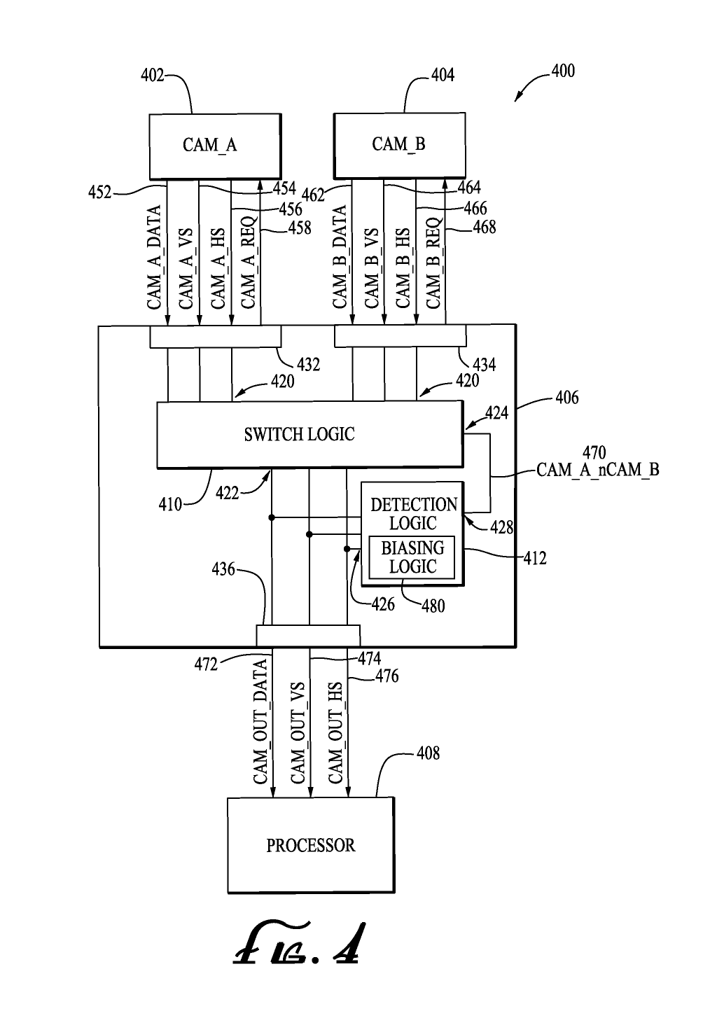

The detection logic 304 may detect an expected or desired portion of image data (e.g., a complete image frame, a partial image frame, a given number of pixels, etc.) based on one of various methodologies. In one embodiment, as shown in FIG. 4 and described in greater detail below with reference to the same, the detection logic 304 may monitor a vertical sync (VSYNC) signal of the presently selected imager 330. The VSYNC signal of the presently selected imager 330 may be received through the presently selected imager interface 332, received at an input 310 of the switching logic 302, then passed (or forwarded) to the output 312 of the switching logic 302, and received at an input 316 of the detection logic 304. The VSYNC signal generally indicates when a complete image frame has been read out of the presently selected imager 330 and, thus, provides indication of when a complete image frame has been passed to the output 312 of the switching logic 302 and on to the processor interface 308.

In another embodiment, the detection logic 304 may detect a desired amount of image data using more complicated algorithms, such as image completion or dead time detection algorithms. The algorithms may be implemented in hardware and/or software. An example algorithm may be implemented according to the following pseudo code:

```
pixel_count = 0;
loop:
    receive pixel data for num_received_pixels;
    pixel_count = pixel_count + num_received_pixels;
    if pixel_count equal total_expected_pixels,
      return image_complete=true;
      pixel_count = 0;
      exit loop;
    else return image_complete=false;
do loop.
```

In one embodiment, the detection logic 304 may include hardware and/or circuitry. In another embodiment, the detection logic 304 may include embedded instructions, for example to implement detection logic and/or apply image completion algorithms and/or dead time detection algorithms. In still another embodiment, the detection logic 304 may include a combination of hardware and software components to implement detection logic and/or apply image completion algorithms and/or dead time detection algorithms. In still another embodiment, the detection logic 304 may include software modules to implement detection logic and/or apply image completion algorithms and/or dead time detection algorithms.

In one embodiment, the detection logic 304 may detect complete image frames because the processing device 328 may be configured to process complete image frames to perform a function. By way of example, and not limitation, the processing device 328 may be configured to identify and/or decode optical codes, such as in a retail POS (point of sale) environment. In such an embodiment, if only partial images (i.e., partial or incomplete image frames) were forwarded to the processing device 328, then the processing device 328 may be limited in performing its intended function, such as identifying and decoding optical codes on items passed through a view volume of a POS. In other embodiments, the processing device 328 may be capable of processing partial image frames to perform a desired function, such as identifying and decoding optical codes.

Once a desired a portion of an image frame (e.g., a complete image frame or a partial image frame) is forwarded on to the processor interface 308 and/or the processing device 328, the presently selected imager interface 332 may be changed. In other words, the detection logic 304 may provide data or a signal at the output 318 that instructs or otherwise indicates to the switching logic 302 to change the presently selected imager interface 332 to another imager interface of the plurality of imager interfaces 306. For example, the presently selected imager 330 may be a first imager interface 340 of the plurality of imager interfaces 306 and the detection logic 304 may change the presently selected imager interface 332 to be a second imager interface 342 of the plurality of imager interfaces 306. Accordingly, data of the second imager interface 342, including image data, is passed to the output 312 of the switching logic 302 and in turn to the processor interface 308 and the processing device 328 coupled thereto. The detection logic 304 again detects when a complete image frame is output to the processor interface 308 and/or the processing device 328 as described above. The detection logic 304 also again determines when to switch the presently selected imager interface from the second imager interface 342 to another of the plurality of imager interfaces 306.

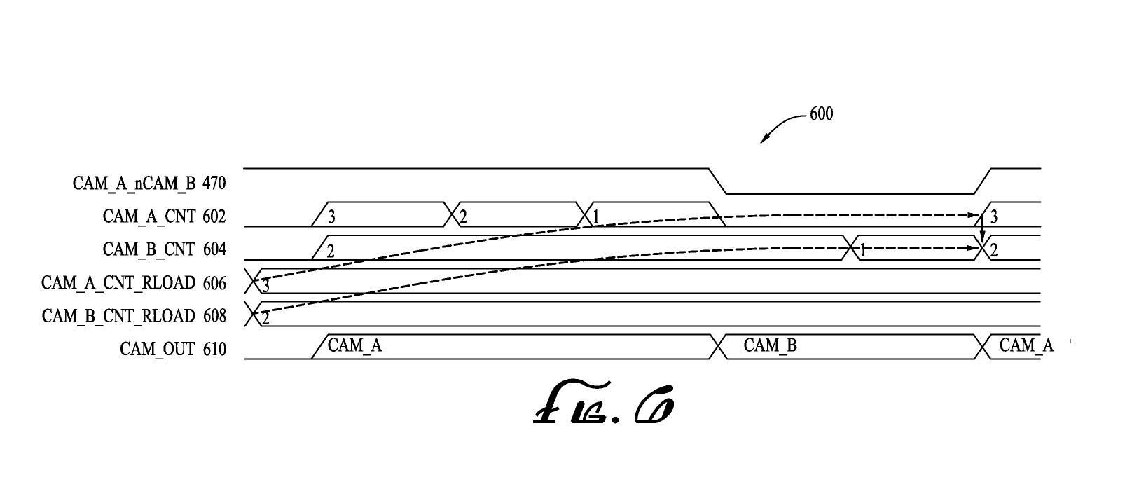

The detection logic 304 may further include, or be coupled to, biasing logic 350 that can be configured to impose a pre-defined bias on the switching order. A particular imager of the plurality of imagers 326 may be better suited for capturing desired image data. By way of example, and not limitation, a bottom imager of an imaging reader may tend to more frequently capture images containing optical codes because an operator may tend to direct the optical code on an item downward into a glass plate (based on an assumption that the window is where scanning occurs). Accordingly, in a given situation, it may be desirable to have the processing device 328 process multiple images from a particular imager for every image from another imager. For example, it may be desirable to process three images captured by a first imager for every image that is processed from a second imager. Accordingly, a bias of 3 to 1 could be pre-defined and/or configured in the biasing logic 350. The biasing logic 350 may also enable the bias to be updated or modified dynamically based on a load, a need (e.g., a change in an operator/checker having different scanning habits than a previous operator/checker), and/or a success rate (e.g., a particular image tends to make more or most of the successful reads). In one embodiment, the biasing logic 350 may comprise one or more counters to track the number of complete frames received from one or more imagers. An embodiment of biasing logic 350 is discussed more fully below with reference to FIG. 6.

The dynamic intelligent imager switch 301 may be appropriately configured to produce a clean and continuous stream of image data that comprises images captured by a plurality of imagers and that can be presented to the processing device 328 as if from a single imager 326. In this manner, the dynamic intelligent imager switch 301 may enable use of a single processing device 328 in imaging reader applications (e.g., systems, scanners) utilizing a plurality of imagers. The processing device 328 can be utilized in the same method and manner that it would be used were it coupled to a single imager 326. In other words, a processing device 328 that is designed and/or configured for use with a single imager in an imaging reader system may now be used, unchanged and without reconfiguration, to process image data received from a plurality of imagers 326.

The appropriate configuration of the dynamic intelligent imager switch 301 may be dictated based on requirements of the processing device 328. Consideration may be given to requirements of the processing device 328 including, but not limited to, an exposure time, a frame rate, a refresh rate, and additional clocks needed before or after receiving a complete image frame or other desired portion of the image frame (e.g., to satisfy a state machine or other hardware requirements or limitations inherent in the processing device 328).

In FIG. 3, the block diagram depicts one example of coupling of the plurality of imagers 326 and the image processing device 328 to the dynamic intelligent imager switch 301 using a single line. As described more fully below, each input 310 may include multiple bits. In other words, the plurality of imager interfaces 306 may each comprise a parallel interface that receives multiple bits (or lines) of data in parallel and passes those multiple bits to the corresponding input 310 of the switching logic 302. The multiple bits may include multiple bits of various data, including but not limited to multiple bits of image data, multiple bits of control data, and/or multiple bits of configuration data. For example, each of the plurality of imager interfaces 306 (and corresponding plurality of inputs 310 to the switching logic 302) may support a parallel interface, such as a camera parallel interface. In other embodiments, each input 310 may be serial such that a single bit is received at a time. The various data, including but not limited to multiple bits of image data, multiple bits of control data, and/or multiple bits of configuration data, may be presented sequentially. For example, each of the plurality of imager interfaces 306 (and/or the corresponding plurality of inputs 310 to the switching logic 302) may support one of the Camera Serial Interface (CSI) specification or a Camera Serial Interface 2 (CSI-2) specification as defined by MIPI Alliance, Inc., the inter-integrated circuit (I²C) interface, or the serial peripheral interface (SPI), among others.

The block diagram of the example dynamic intelligent imager switch 301 of FIG. 3 also depicts the imager interfaces 306 as separate and distinct from the inputs 310 of the switching logic 302. In some embodiments, the switching logic 302 may include the imager interface 306, such that the multiple inputs 310 of the switching logic 302 comprise the plurality of imager interfaces 306. Similarly, FIG. 3 depicts the processor interface 308 as separate and distinct from the output 312 of the switching logic 302. In some embodiments, the switching logic 302 may include the processor interface 308, such that the output 312 of the switching logic 302 comprises the processor interface 308. All or a portion of the output 312 of the switching logic 302 and/or the processor interface 308 may be directed to the detection logic 304 for use in detecting when a complete image frame is presented at the processor interface 308.

FIG. 4 is a block diagram of a data reader 400 for reading an optical code on an item, according to one embodiment. The data reader 400 comprises camera A 402 (a first imaging device), camera B 404 (a second imaging device), a dynamic intelligent imager switch 406, and a processor 408 (or other processing device). The system 400 may be configured to be utilized, for example, at a retail POS to scan items to be purchased. The system 400 may scan each item to be purchased to identify the item and a price for purchasing that item. The system 400 may total the prices of all the items to be purchased and further aid an operator (e.g., a checker) in performing the purchase transaction.

The camera A 402 and the camera B 404 may comprise a CCD (charge coupled device), CMOS (complementary metal oxide semiconductor) device, imaging array, or other suitable device for generating electronic image data in digital form. The FOV of the camera A 402 and the camera B 404 may be directed to a view volume (see FIG. 2) of the data reader 400 to capture image data (e.g., a digital image) of an item as it is passed through the view volume. The FOV of each of the camera A 402 and the camera B 404 may define a portion of the view volume. Image data captured by the camera A 402 is output on a connection CAM_A_DATA 452 to a first imager interface 432 of the dynamic intelligent imager switch 406. Additional data, which may include control data and/or configuration data, may also be output by the camera A 402 on a connection to the first imager interface 432. In the illustrated embodiment of FIG. 4, the first imager interface 432 may be a parallel interface that can receive multiple image data bits and/or other data bits in parallel. The connection CAM_A_DATA 452 may include a plurality of bits, such that multiple bits of image data can be output/transferred in parallel. By way of example, and not limitation, the connection CAM_A_DATA 452 may include ten bits to transfer ten bits of image data in parallel. A single pixel of an image frame may comprise ten bits, thus allowing an entire pixel to be transferred in parallel. The data output from camera A 402 may also include a vertical sync (VSYNC) signal that is output on a connection CAM_A_VS 454 to the first imager interface 432 and/or a horizontal sync (HSYNC) signal that is output on a connection CAM_A_HS 456 to the first imager interface 432.

Similarly, image data captured by the camera B 404 is output on a connection CAM_B_DATA 462 to a second imager interface 434 of the dynamic intelligent imager switch 406. Additional data, which may include control data and/or configuration data, may also be output by the camera B 404 on a connection to the second imager interface 434. In the illustrated embodiment of FIG. 4, the second imager interface 434 may be a parallel interface that can receive multiple image data bits and/or other data bits in parallel. The connection CAM_B_DATA 462 may include a plurality of bits, such that multiple bits of image data can be output/transferred in parallel. By way of example, and not limitation, the connection CAM_B_DATA 462 may include ten bits to transfer ten bits of image data in parallel. A single pixel of an image frame may comprise ten bits, thus allowing an entire pixel to be transferred in parallel. The data output from camera B 404 may also include a vertical sync (VSYNC) signal that is output on a connection CAM_B_VS 464 to the second imager interface 434 and/or a horizontal sync (HSYNC) signal that is output on a connection CAM_B_HS 466 to the second imager interface 434.

As illustrated in FIG. 4, the imager interfaces 432, 434 receive image data, a VSYNC signal, and an HSYNC signal from a corresponding imager. The imager interfaces 432, 434 may also provide to the imager a request signal, such as on a connection CAM_A_REQ 458 and a connection CAM_B_REQ 468, respectively. The request signal may indicate to the respective camera 402, 404 to capture a new image, for example, because the processor 408 and/or the dynamic intelligent imager switch 406 is prepared to receive and/or process additional image data and/or a new complete image frame.

The dynamic intelligent imager switch 406 may receive data at a plurality of imager interfaces, such as the first imager interface 432 and the second imager interface 434, and dynamically and intelligently pass (or forward) to the processor interface 436 all or a portion of the data received at a presently selected imager interface. For example, if the presently selected imager interface were the first imager interface 432, the dynamic intelligent imager switch 406 may be configured to pass (or forward) to the processor interface 436 all or a portion of the data received from the camera A 402. Furthermore, the dynamic intelligent imager switch 406 may also dynamically and intelligently change the presently selected imager interface to be the second imager interface 434. The dynamic intelligent imager switch 406 may perform dynamic intelligent switching, for example, by detecting when a complete image frame, received at the first imager interface 432 (also the presently selected imager interface), has been passed (or forwarded) to the processor interface 436 and/or the processor 408 and then switching the presently selected imager interface to the second imager interface 434 after the complete frame has been passed to the processor interface 436 and/or the processor 408. The switching between imager interfaces may be accomplished automatically. Manual switching and/or external input may be unnecessary. In another embodiment, the dynamic intelligent imager switch 406 may perform dynamic intelligent switching, for example, by detecting imager dead time (e.g., a period after a complete image frame is read out and before a next image frame begins to be read out) of a presently selected imager. The dead time may be an indication that a complete image frame has been read out and that switching between imager interfaces can be accomplished safely (e.g., without corrupting, damaging, and/or comingling image data in a stream of data presented to the processor 408.

In the embodiment of FIG. 4, the dynamic intelligent imager switch 406 may include switching logic 410 and detection logic 412. The switching logic 410 may be configured to receive data from the cameras 402, 404 and select data from one of the cameras 402, 404 to pass (or forward) to the processor interface 436 and/or the processor 408. As described above, the switching logic 410 may receive data at multiple inputs 420 and select and pass all or a portion of the data received at one of the inputs 420 to a single output 422. As shown, the inputs 420 and output 422 may include multiple lines. In other words, an input 420 may include a set of inputs (or input lines) and the output 422 may include a set of outputs (or output lines). In other words, the switching logic 410 may receive data at multiple sets of inputs 420 and select and pass all or a portion of the data received at one set of inputs 420 to a single set of outputs 422. The switching logic 410 may select which input 420 to pass to the output 422 based on a selection input 424 received from the detection logic 412. The switching logic 410 may select a presently selected imager interface (one of the first imager interface 432 or second imager interface 434) based on the selection input 424 received from the detection logic 412.

The detection logic 412 detects when a complete image frame has been communicated to the processor interface 436 and/or the processor 408. More specifically, the detection logic 412 may receive as an input 426 all, or at least a portion, of the output 422 of the switching logic 410 and detect when a complete image frame is passed from the output 422 of the switching logic 410 to the processor interface 436. Once a complete image frame is detected (and passed to the processor interface 436 and/or the processor 408), the detection logic 412 may provide an output 428 that is communicated to the switching logic 410 to instruct or otherwise indicate to the switching logic 410 which input 420 to select to pass to the output 422. In other words, the output 428 of the detection logic 412 may be communicated to the switching logic 410 as the selection input 424 of the switching logic 410.

The detection logic 412 may detect a complete image by monitoring a vertical sync (VSYNC) signal received at the presently selected imager interface. The VSYNC signal of the presently selected imager interface, for example the first imager interface 432, may be received at an input 420 of the switching logic 410, passed to the output 422 of the switching logic 410, and received at an input 426 of the detection logic 412. For example, the VSYNC signal of the camera A 402 may initially be low (e.g., negative or zero) and may go high (e.g., positive) when the camera A 402 begins reading out a captured image. The VSYNC signal may be communicated on the connection CAM_A_VS 454 to the first imager interface 432. Once the last pixel of the last row of a captured image frame has been read out by the camera A 402, the VSYNC signal may go low again to indicate a complete image frame has been read-out. The low VSYNC signal on the connection CAM_A_VS 454 to the first imager interface 432 is passed to the output 422 of the switching logic and received at the input 424 of the detection logic 412. The detection logic 412 detects the low VSYNC signal and may provide on the output 428 of the detection logic 412 a selection signal to the switching logic 410 whether to change the presently selected imager interface. The selection signal may be communicated from the detection logic 412 to the switching logic 410 on a connection CAM_A_nCAM_B 470. The detection logic 412 may perform the same or a similar monitoring of a VSYNC signal of camera B 404 when the presently selected imager interface is the second imager interface 434.

The processor interface 436 passes the output 422 of the switching logic 410 to the processor 408. In the illustrated embodiment of FIG. 4, the processor interface 436 corresponds to the outputs of the imagers, namely the camera A 402 and the camera B 404. Specifically, the processor interface 436 may couple to a connection CAM_OUT_DATA 472, a connection CAM_OUT_VS 474, and a connection CAM_OUT_HS 476. The processor interface 436 may correspond to the outputs of the imagers so that the dynamic intelligent imager switch 406 can couple to the processor 408. The coupling of the dynamic intelligent imager switch 406 to the processor 408 may be in a manner that leaves the processor 408 unchanged and without any modification or reconfiguration.

In the foregoing manner, the dynamic intelligent imager switch 406 may produce a clean and continuous stream of image data that comprises images captured by the camera A 402 and the camera B 404 and present the continuous stream of image data to the processor 408 as if all the images originated from a single imager. Thus, the dynamic intelligent imager switch 406 enables use of a single processor 408 in the illustrated data reader 400 with two imagers, namely, the camera A 402 and the camera B 404. The processor 408 may have a single imager interface, and may be programmed or otherwise configured to interact with a single imager (e.g., one of the camera A 402 or the camera B 404), but the dynamic intelligent imager switch 406 allows the processor 408 to be utilized in the same method and manner that it would be used were it coupled to a single imager. In other words, a processor 408 that is designed and/or configured for use with one of the camera A 402 and/or the camera B 404 in an imaging reader application (e.g., system, scanner) may now be used, unchanged and without reconfiguration, to process image data received from both of the camera A 402 and the camera B 404.

The detection logic 412 may further include, or be coupled to, biasing logic 480 that can be configured to impose a pre-defined bias on the switching order, as described above. The biasing logic 480 may include one or more counters. A first counter may count to ensure that a given number of complete image frames are passed to the processor 408 from the first imager interface 432, for example, before switching the presently selected imager interface from the first imager interface 432 to the second imager interface 434. A second counter may count to ensure that a given number of complete image frames are passed to the processor 408 from the second imager interface 434, for example, before switching the presently selected imager interface from the second imager interface 434 to the first imager interface 432. For example, it may be desirable to process three images captured by the camera A 402 for every two images that are processed from the camera B 404. Accordingly, a bias of 3-to-2 could be pre-defined or configured in the biasing logic 480. The biasing logic 350 (see FIG. 3) may also enable the bias to be updated or modified dynamically based on a load or need (e.g., a change in an operator/checker having different scanning habits than a previous operator/checker).

In another embodiment, a dynamic intelligent imager switch may include additional features. By way of example, and not limitation, the dynamic intelligent imager switch may further include translation logic that would enable a plurality of imagers having a first type of interface (e.g., the parallel interface depicted in FIG. 4) to be dynamically and intelligently coupled and switched to a processing device having a second type of interface (e.g., a MIPI compliant interface). The dynamic intelligent imager switch may detect a complete image frame and instigate switching of the switching logic, as described above. The translation logic may simply receive data from the output of the switching logic, such as for example in a format compliant with the first type of interface, and automatically translate the data into a format compliant with the second type of interface before passing the data on to the processor interface. In still other embodiments, the plurality of imager interfaces may differ from each other and may be translated into a format compliant with the inputs of the switching logic.

An example embodiment may be a dynamic intelligent imager switch that includes a plurality of imager interfaces, a processor interface, switching logic, and detection logic. The plurality of imager interfaces are operative to couple to a plurality of imagers. The plurality of imagers are configured to capture image data of a scene in a field of view (FOV) of the imager and present the captured image data as an output. The processor interface couples to an imager interface of a processing device. The processing device is configured to process image data captured by the plurality of imagers and identify and decode an optical code within the image data. The switching logic forwards, to the processor interface, image data received at a presently selected imager interface of the image data switching logic. The detection logic is configured to detect that a complete image frame is received at the presently selected imager interface and forwarded to the processor interface, before automatically switching the presently selected imager interface of the switching logic from a first imager interface of the plurality of imager interfaces to a second imager interface of the plurality of imager interfaces.

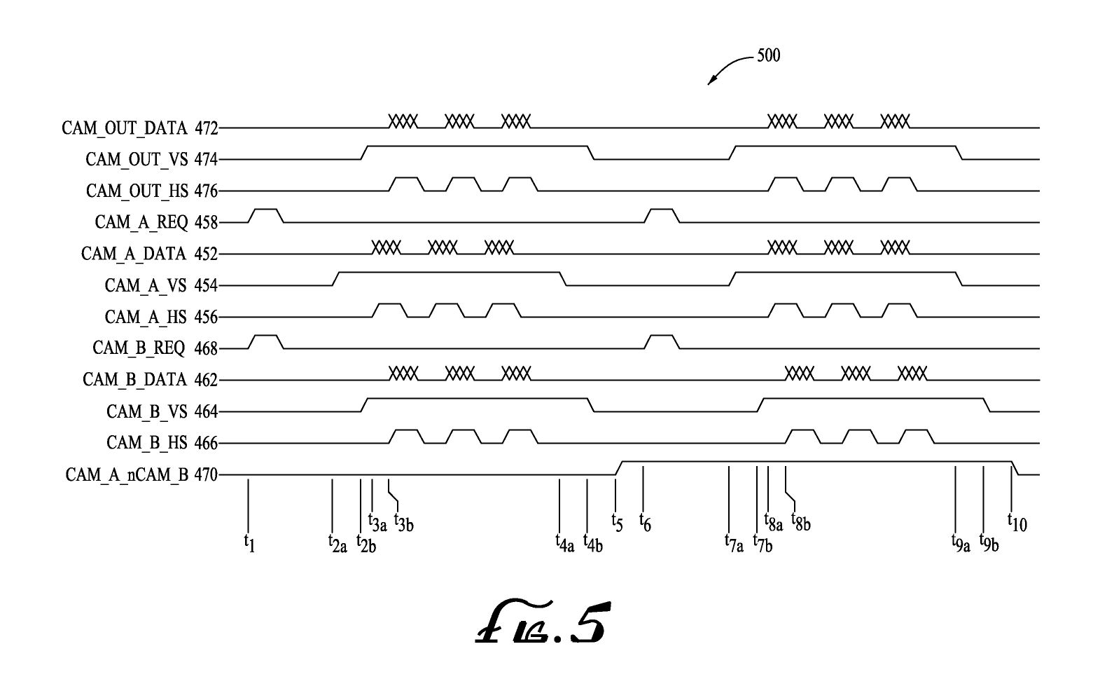

FIG. 5 is an example timing diagram 500 of dynamic intelligent imager switching in the data reader 400 of FIG. 4, according to one embodiment. The timing diagram depicts signals/data present on the connections diagrammed in FIG. 4. The timing diagram 500 is described with reference to components shown in FIG. 4, connections shown in FIG. 4, and signals/data shown in FIG. 5 on the connections at various points in time. For sake of simplicity, in the illustrated example, the signals/data all begin in a low state. The signal on the connection CAM_A_nCAM_B 470 is low, indicating that the selection signal received at the selection input 424 of the switching logic 410 is set to select the second imager interface 434, which is coupled to the camera B 404. In other words, initially in FIG. 5, the presently selected imager interface is the second imager interface 434 and the switching logic 410 is configured (or set) to pass data received from the camera B 404 at the second imager interface 434 to the processor interface 436. Also, data from the camera B 404 is being received at the input 426 of the detection logic 412.

An imager request signal on the connection CAM_A_REQ 458 and an imager request signal on the connection CAM_B_REQ 468 are provided at time tᵢ to indicate to the camera A 402 and the camera B 404 that an image is being requested (e.g., by the processor 408 or the dynamic intelligent imager switch 406). The request signals are shown in the illustrated embodiment by a rising edge (i.e., the transition from low to high) and, shortly thereafter, a falling edge (i.e., the transition from high to low), but, as can be appreciated, other signal patterns are possible. Furthermore, although the request signals on connection CAM_A_REQ 458 and connection CAM_B_REQ 468 are coincident at time t₁, they may also be non-coincident so as to ensure alignment of imager dead times, as appropriate. These request signals start the imagers sending image data, which is signified by a rising edge of the VSYNC signals on the connection CAM_A_VS 454 and on the connection CAM_B_VS 464. A slight phase delay between the two imagers (including their VSYNC signals) is shown to illustrate which of the camera's data is being passed to the output 422 of the switching logic 410 and/or the processor interface 436. Specifically, the VSYNC signal of the camera A 402 on the connection CAM_A_VS 454 has a rising edge at time t₂ₐ and the VSYNC signal of the camera B 404 on the connection CAM_B_VS 464 has a rising edge at time t_{2b}. Because the switching logic 410 is set to select the data received at the second imager interface 434, which is coupled to the camera B, the VSYNC signal on the connection CAM_B_VS 464 also appears at time t_{2b} on the connection CAM_OUT_VS 474.

With the VSYNC signals high, the camera A 402 and the camera B 404 begin to transfer (read out) image data. The transfer of image data involves HSYNC signals to indicate a beginning of a transfer (read out) of a row of pixels. Specifically, an HSYNC signal on the connection CAM_A_HS 456 has a rising edge at time t₃ₐ, and corresponds to image data being transferred (read out) on the connection CAM_A_DATA 452 at time t₃ₐ. An HSYNC signal on the connection CAM_B_HS 466 has a rising edge at time t_{3b} and corresponds to image data being transferred (read out) on the connection CAM_B_DATA 462 at time t_{3b}. Again, because the switching logic 410 is set to select the data received at the second imager interface 434, which is coupled to the camera B 404, the HSYNC signal on the connection CAM_B_HS 466 also appears at time t_{3b} on the connection CAM_OUT_HS 476 and the image data being read out also appears on the connection CAM_OUT_DATA 472 at time t_{3b}.

For ease of description, in the timing diagram 500 of FIG. 5, only three HSYNC signals are shown on each of the connection CAM_A_HS 456, the connection CAM_B_HS 466, and the connection CAM_OUT_HS 476 and only three rows of data are shown being transferred on each of the connection CAM_A_DATA 452, the connection CAM_B_DATA 462, and the connection CAM_OUT_DATA 472. However, as can be appreciated, any suitable number of HSYNC signals and transfer of rows of pixels of an image may occur during transfer of an image, prior to a falling edge of the VSYNC signal. The actual number of HSYNC signals and transfer of rows of pixels may depend on the size, or number of rows of pixels, of the image frame.

After all rows of pixels of an image frame have been transferred (or read out), the VSYNC signal falls to indicate the most recently captured image frame has been completely read out. In FIG. 5, the VSYNC signal on the connection CAM_A_VS 454 has a falling edge at time t₄, and the VSYNC signal on the connection CAM_B_VS 464 has a falling edge at time t_{4b}. Because the switching logic 410 is set to select the data received at the second imager interface 434, which is coupled to the camera B 402, the falling edge of the VSYNC signal on the connection CAM_B_VS 464 also appears at time t_{4b} on the connection CAM_OUT_VS 474.

In the illustrated example of FIG. 4, the detection logic 412 detects the falling VSYNC signal on the connection CAM_OUT_DATA 472 at time t_{4b} and causes the signal on the connection CAM_A_nCAM_B 470 to switch from low to high. The rising edge of the signal on the connection CAM_A_nCAM_B 470 is shown at time t₅.

A high signal on the connection CAM_A_nCAM_B 470 indicates that the selection signal received at the selection input 424 of the switching logic 410 is now set to select the first imager interface 432, which is coupled to the camera A 402. In other words, at time t₅ the presently selected imager interface becomes the first imager interface 432 and data from the camera A 402 is now being passed by the switching logic 410 to the processor interface 436. Also, data from the camera A 402 is now being received at the input 426 of the detection logic 412.

Another imager request signal on the connection CAM_A_REQ 458 and another imager request signal on the connection CAM_B_REQ 468 are provided at time t₆ to indicate to the camera A 402 and the camera B 404 that an image is being requested (e.g., by the processor 408 or the dynamic intelligent imager switch 406). These request signals prompt the cameras 402, 404 to begin sending image data, which is signified by a rising edge of the VSYNC signals on the connection CAM_A_VS 454 and on the connection CAM_B_VS 464. Again, a slight phase delay between the two imagers (including their VSYNC signals) is shown to illustrate which camera's data is being passed to the output 422 of the switching logic 410 and/or the processor interface 436. Specifically, the VSYNC signal of the camera A 402 on the connection CAM_A_VS 454 has a rising edge at time t₇ₐ and the VSYNC signal of the camera B 404 on the connection CAM_B_VS 464 has a rising edge at time t_{7b}. Because the switching logic 410 is set to select the data received at the first imager interface 432, which is coupled to the camera A 402, the VSYNC signal on the connection CAM_A_VS 454 also appears at time t₇ₐ on the connection CAM_OUT_VS 474.

With the VSYNC signals high, the camera A 402 and the camera B 404 begin to transfer (read out) image data. As before, the transfer of image data involves the HSYNC signals to indicate a beginning of a transfer (read out) of a row of pixels. The HSYNC signal on the connection CAM_A_HS 456 has a rising edge at time t₈, and corresponds to image data being transferred (read out) on the connection CAM_A_DATA 452 at time t₈ₐ. The HSYNC signal on the connection CAM_B_HS 466 has a rising edge at time t_{8b} and corresponds to image data being transferred (read out) on the connection CAM_B_DATA 462 at time t_{8b}. Again, because the switching logic 410 is set to select the data received at the first imager interface 432, which is coupled to the camera A 402, the HSYNC signal on the connection CAM_A_HS 456 also appears at time 6 on the connection CAM_OUT_HS 476 and the image data being read out also appears on the connection CAM_OUT_DATA 472 at time 6. Again, for ease of description, only three rows of data are shown as being transferred.

After all rows of pixels of an image frame have been transferred (or read out) from the camera A 402, the VSYNC signal falls to indicate the most recently captured image frame has been completely read out. In FIG. 5, the VSYNC signal on the connection CAM_A_VS 454 has a falling edge at time t₉ₐ and the VSYNC signal on the connection CAM_B_VS 464 has a falling edge at time t_{9b}. Because the switching logic 410 is set to select the data received at the first imager interface 432, which is coupled to the camera A 402, the falling edge of the VSYNC signal on the connection CAM_A_VS 454 also appears at time t₉ₐ on the connection CAM_OUT_VS 474.

In the illustrated example of FIG. 4, the detection logic 412 detects the falling VSYNC signal on the connection CAM_OUT_DATA 472 at time t₉ₐ and causes the signal on the connection CAM_A_nCAM_B 470 to switch from high to low. The falling edge of the signal on the connection CAM_A_nCAM_B 470 is shown at time t₁₀.

The low signal on the connection CAM_A_nCAM_B 470 indicates that the selection signal received at the selection input 424 of the switching logic 410 is again set to select the second imager interface 434, which is coupled to the camera B 404. In other words, at time t₁₀ the presently selected imager interface again becomes the second imager interface 434 and data from the camera B 404 is passed by the switching logic 410 to the processor interface 436 and received at the input 426 of the detection logic 412.

In the illustrated timing diagram 500 of FIG. 5, many of the signals may be, in essence, a single bit binary signal with two states, namely high and low. However, it can be appreciated that more than two values/states may be used. For example, the signals may be communicated over connections having a plurality of bits, such that a range of values is possible. In data readers having more than two imagers, the connection CAM_A_nCAM_B 470 may be replaced by a multi-bit connection CAM_SEL that includes a plurality of bits and can be set to any of more than two states (e.g. a two bit connection with four states—namely 00, 01, 10, 11).

The data transfer on each of the connection CAM_A_DATA 452, the connection CAM_B_DATA 462, and the connection CAM_OUT_DATA 472 is depicted using the notation “XXXX.” This notation may refer to any number of individual bits and/or any suitable number of pixels. A pixel may comprise any suitable number of individual bits, and thus a serial transfer of a pixel may nevertheless involve parallel transfer of a plurality of bits. The individual bits may be transferred serially, or may be transferred in parallel sets, or entirely in parallel. Also, the pixels may be transferred serially or in parallel with any combination of other pixels.

In one embodiment, a complete image frame may be 1000×1000 pixels. Each of the thousand rows is communicated on a single HSYNC signal, as shown in FIG. 5. Each pixel of each row may comprise ten bits that are communicated in parallel on a ten bit connection. The ten bits of each pixel may enable communication of various information, including color information. The pixels are communicated in a serial fashion, such that the ten bits of a single pixel are read out at a time.

In other embodiments, the pixels may be communicated in other ways. In one embodiment, each pixel may be transferred individually in a serial fashion, as described above. Alternatively, each pixel of each row may be transferred in parallel with any combination of other number of pixels, such as one hundred sets of ten pixels (e.g. one hundred bits at a time if pixels are ten bits) in parallel, fifty sets of twenty pixels (e.g., two hundred bits at a time if pixels are ten bits) in parallel, etc.

Furthermore, the interfaces and the individual connections may further include additional data not shown. For example, a pixel clock signal may be communicated on a connection between the imagers 402, 404, the dynamic intelligent imager switch 406, and the processor 408. The pixel clock signal may indicate when an individual pixel is transferred, if transferred serially, or may indicate when a parallel set of pixels is transferred.

FIG. 6 is an example timing diagram 600 illustrating biasing in dynamic intelligent imager switching, according to one embodiment. As described above, a dynamic intelligent imager switch may further comprise biasing logic. The detection logic may include, or be coupled to, the biasing logic. The biasing logic may be configured to impose a pre-defined bias on the switching order, as described above. The timing diagram 600 of FIG. 6 illustrates an example of the relative timing of state changes of various counters and a selection signal on the connection CAM_A_nCAM_B 470. The timing diagram 600 in FIG. 6 is explained below with reference to components of the data reader 400 of FIG. 4.

A first counter CAM_A_CNT 602 may count to ensure that a given number of complete image frames are passed to the processor 408 from the first imager interface 432 (which is coupled to the camera A 402) before switching the presently selected imager interface from the first imager interface 432 to the second imager interface 434. In the illustrated scenario of FIG. 6, the signal on the connection CAM_A_CNT_RLOAD 606 is set to three to preload the first counter CAM_A_CNT 602 to have three counts. The signal on the connection CAM_B_CNT_RLOAD 608 is set to two to preload the second counter CAM B_CNT 604 to have two counts.

Initially the connection CAM_A_nCAM_B 470 is set high, which causes the switching logic 410 to pass the data from the camera A 402 to the output CAM_OUT 610. Each time a complete image frame is received, the first counter CAM_A_CNT 602 is decremented, while the second counter CAM_B_CNT 604 remains at two. When the first counter CAM_A_CNT 602 hits zero, the detection logic changes the signal on the connection CAM_A_nCAM_B 470 from high to low, which causes the switching logic 410 to pass the data from the camera B 404 to the output CAM_OUT 610. When a complete image frame is received, the second counter CAM_B_CNT 604 is now decremented. When both counters 602, 604 are at zero, they are reloaded with the values provided on the connection CAM_ACNT_RLOAD 606 and the connection CAM_B_CNT_RLOAD 608, respectively, and the process repeats.

In this manner, the biasing logic ensures that a given number of complete image frames are passed to the processor 408 from the presently selected imager before switching the presently selected imager. Dynamic modification of the signals on the connection CAM_A_CNT_RLOAD 606 and the connection CAM B CNT RLOAD 608 may enable the bias to be updated or modified dynamically based on a load or need (e.g., a change in an operator/checker having different scanning habits than a previous operator/checker).

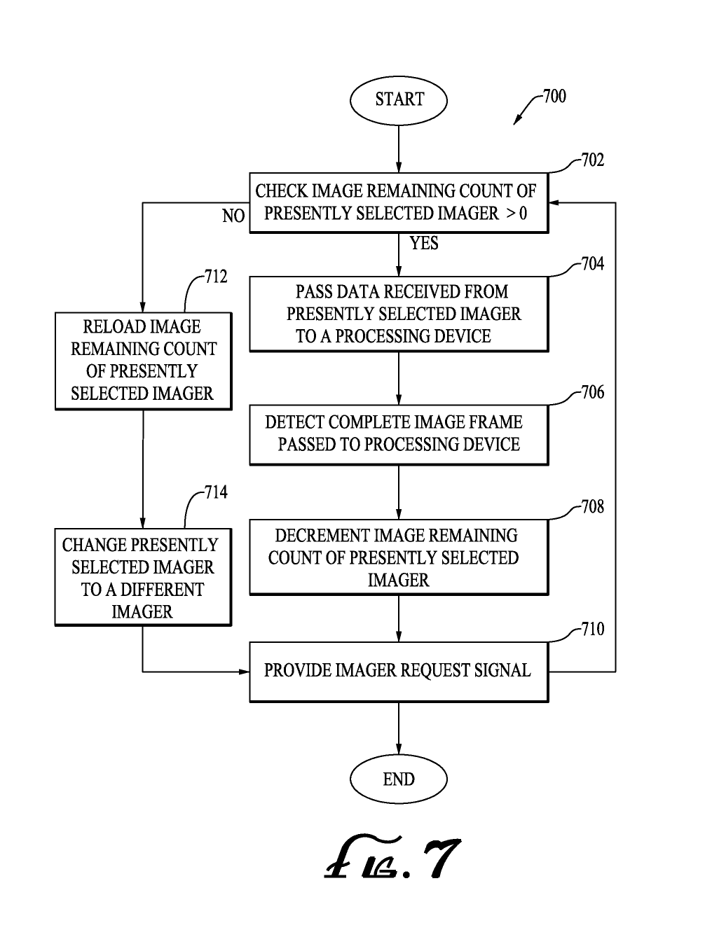

FIG. 7 is a flow diagram of a method 700 of dynamic intelligent imager switching, according to one embodiment. An image remaining count that corresponds to the presently selected imager interface is checked (step 702). If the image remaining count is greater than zero (yes from step 702), data received from the presently selected imager is passed (step 704) or otherwise transmitted to a processing device (or interface to a processing device). The passed data may include image data. The image data is analyzed and a complete image frame is detected (step 706), to ensure that the processing device is receiving complete images, or at least substantially complete images (recognizing that on occasion portions of an image frame may be corrupted, improperly read out, etc. or one or more pixels of an imager may be defective or damaged). The image remaining count can be decremented (step 708) to account for the complete image passed to the processing device or interface. Then an imager request signal can be provided (step 710) to the imagers to request a new image capture.

If the image remaining count is equal to zero upon a check (no from step 702), the image remaining count may be reloaded (step 712) with a pre-defined count according to the desired bias. The presently selected imager is also changed (step 714) to a different imager. An imager request signal can be provided (step 710) to the imagers to request a new image capture. The method 700 is then repeated with the new presently selected imager and based on its corresponding image remaining count.

In another embodiment, the image remaining count of all counters may be reloaded (step 712) with their respective pre-load amounts after all counters, or a plurality of counters, reach zero and/or contemporaneously with the change (step 714) to a different imager.

Other embodiments are envisioned. Although the description above contains certain specific details, these details should not be construed as limiting the scope of the invention, but as merely providing illustrations of some embodiments/examples. It should be understood that subject matter disclosed in one portion herein can be combined with the subject matter of one or more of other portions herein as long as such combinations are not mutually exclusive or inoperable.

The terms and descriptions used herein are set forth by way of illustration only and not meant as limitations. It will be obvious to those having skill in the art that many changes may be made to the details of the above-described embodiments without departing from the underlying principles of the invention(s). The scope of the present invention should, therefore, be determined only by the following claims.

1. A data reader comprising:
a plurality of imagers operative to capture image data that can be used to identify and decode an optical code disposed on an item passed through a view volume of the data reader, each imager of the plurality of imagers having a field of view (FOV) directed to and defining at least a portion of the view volume of the data reader and configured to capture image data of a scene in the FOV when triggered;
a processing device configured to process image data to identify and decode an optical code within the image data, the processing device having a an imager interface; and
a dynamic intelligent imager switch that couples the plurality of imagers to the imager interface of the processing device and provides to the processor a single stream of image data that includes a desired portion of multiple image frames captured by multiple of the plurality of imagers.

2. The data reader of claim 1, wherein the dynamic intelligent imager switch presents the stream of image data to the imager interface of the processing device as if the multiple complete image frames are from a single imager.

3. The data reader of claim 1, wherein the desired portion of an image frame is a complete image frame.

4. The data reader of claim 1, wherein the dynamic intelligent imager switch comprises:
a plurality of imager interfaces coupled to the plurality of imagers;
a processor interface coupled to the imager interface of the processing device;
switching logic to forward, to the processor interface, image data received at a presently selected imager interface of the dynamic intelligent imager switch, the presently selected imager interface comprising one of the plurality of imager interfaces; and
detection logic operative to detect a desired portion of an image frame in first image data that is received at the presently selected imager interface and forwarded to the processor interface, the detection logic further operative to automatically switch the presently selected imager interface of the dynamic intelligent imager switch from a first imager interface of the plurality of imager interfaces to a second imager interface of the plurality of imager interfaces.

5. The dynamic intelligent imager switch of claim 4, wherein the detection logic further comprises biasing logic to detect that a desired portion of multiple image frames are received at the presently selected imager interface, and forwarded to the processor interface, before switching the presently selected imager interface from the first imager interface to the second imager interface.

6. The data reader of claim 5, wherein the biasing logic comprises a first counter that can be preloaded with a desired number of desired portions of image frames to be detected before switching the presently selected imager interface from the first imager interface to the second imager interface.

7. The data reader of claim 4, wherein the detection logic is further configured to detect a desired portion of an image frame in second image data that is received at the presently selected imager interface and forwarded to the processor interface, before switching the presently selected imager interface from the second imager interface to a different imager interface of the plurality of imager interfaces.

8. The data reader of claim 7, wherein the different imager interface is a third imager interface of the plurality of imager interfaces.

9. The data reader of claim 7, wherein the different imager interface is the first imager interface.

10. The dynamic intelligent imager switch of claim 7, wherein the detection logic further comprises biasing logic to detect that a desired portion of multiple image frames are received at the presently selected imager interface, and forwarded to the processor interface, before switching the presently selected imager interface from the first imager interface to the second imager interface and before switching the presently selected imager interface from the second imager interface to the different imager interface.

11. The data reader of claim 10, wherein the biasing logic comprises:
a first counter that can be preloaded with a desired number of desired portions of image frames to be detected before switching the presently selected imager interface from the first imager interface to the second imager interface; and
a second counter that can be preloaded with a desired number of desired portions of image frames to be detected before switching the presently selected imager interface from the second imager interface to the different imager interface.

12. The data reader of claim 4, wherein the switching logic comprises a multiplexer.

13. The data reader of claim 1, wherein each imager interface of the plurality of imager interfaces comprises a serial interface.

14. The data reader of claim 1, wherein each imager interface of the plurality of imager interface comprises a parallel interface.

15. The data reader of claim 14, the parallel interface comprising:
an image data input to couple to an image data output of a corresponding imager and operative to receive image data output from the corresponding imager;
a vertical sync input to couple to a VSYNC output from the corresponding imager, the vertical sync input configured to receive, over a connection to the VSYNC output, a first VSYNC signal that indicates the corresponding imager is beginning to send a captured image frame on the image data output and configured to receive a second VSYNC signal that indicates that a last row of pixels of the captured image frame have been sent on the image data output;
a horizontal sync input to couple to a HSYNC output from the corresponding imager, the horizontal sync input configured to receive over a connection to the HSYNC output a first HSYNC signal that indicates the corresponding imager is beginning to send a row a pixels of the captured image frame on the image data output and receive a second HSYNC signal that indicates that a last pixel of the row of pixels has been sent on the image data output; and
an imager request output to send an image request signal to the corresponding imager.

16. The data reader of claim 15, wherein the image data input comprises a plurality of bits to receive, in parallel, a plurality of image data bits over the connection to the image data output of the corresponding imager.

17. The data reader of claim 15, wherein the detection logic detects that a desired portion of an image frame is received, and forwarded to the processor interface, by monitoring changes in VSYNC signals received at the vertical sync input.

18. The data reader of claim 15, wherein the detection logic detects that a desired portion of an image frame is received, and forwarded to the processor interface, by counting received pixels and comparing against an expected number of pixels in a desired portion of an image frame.

19. The data reader of claim 4, wherein the processor interface comprises a parallel interface.

20. The data reader of claim 19, wherein the parallel interface of the processor interface comprises:
an image data output to forward image data to the processing device;
a vertical sync output to forward VSYNC signals to the processing device that are received at the presently selected imager interface; and
a horizontal sync output to forward HSYNC signals to the processing device that are received at the presently selected imager interface.

21. The data reader of claim 20, wherein the image data output comprises a plurality of bits to forward, in parallel, a plurality of image data bits to the processing device.

22. The data reader of claim 1, wherein the processing device has only a single imager interface.

23. A method of reading an optical code, the method comprising:
receiving image data at one or more imager interfaces of a plurality of imager interfaces, each imager interface of the plurality of imager interfaces coupled to a corresponding imager configured to capture image data that can be used to identify and decode an optical code disposed on an item, each corresponding imager comprising one of a plurality of imagers;
forwarding image data received at a presently selected imager interface to a processing device configured to process the image data to identify and decode an optical code within the image data, the presently selected imager interface comprising one of the plurality of imager interfaces;
detecting that first image data received at the presently selected imager interface, and forwarded to the processing device, includes a desired portion of an image frame;
in response to detecting the complete image frame within the first image data, automatically switching the presently selected imager interface from a first imager interface of the plurality of imager interfaces to a second imager interface of the plurality of imager interfaces; and
processing, by the processing device, the image data forwarded to the processing device to identify and decode an optical code.

24. The method of claim 23, wherein the desired portion of an image frame is a complete image frame.

25. The method of claim 23, further comprising:
providing an imager request signal on an imager request output of each of the plurality of imager interfaces.

26. The method of claim 23, further comprising:
checking an image remaining count of one or more image remaining counters, wherein forwarding the image data received at the presently selected imager interface occurs if an image remaining count that corresponds to the presently selected imager interface is greater than zero; and
in response to detecting the desired portion of an image frame within the image data, decrementing the image remaining count that corresponds to the presently selected imager interface, wherein automatically switching the presently selected imager interface from the first imager interface to the second imager interface occurs if the image remaining count that corresponds to the presently selected imager interface is equal to zero, and wherein the image remaining count is reloaded contemporaneous with the automatically switching.

27. The method of claim 23, wherein the detecting that the first image data includes a desired portion of an image frame comprises:
receiving a VSYNC signal that indicates that a last row of pixels of the captured image frame has been sent on an image data output from the corresponding imager coupled to the presently selected imager interface.

28. The method of claim 23, wherein the detecting a desired portion of an image frame further comprises detecting a delay following receiving and forwarding of a complete image frame.

29. A data reader for reading an optical code on an item, the data reader comprising:
a plurality of imagers configured to capture image data that can be used to identify and decode an optical code disposed on an item passed through a view volume of the data reader, each imager of the plurality of imagers having a field of view (FOV) directed to and defining at least a portion of the view volume of the data reader and configured to capture image data of a scene in the FOV when triggered;
a processing device configured to process image data captured by a single imager and identify and decode an optical code within the image data, the processing device having a single imager interface; and
a dynamic intelligent imager switch that couples the plurality of imagers to the single imager interface of the processing device and provides to the processor a stream of image data that includes complete image frames captured by multiple of the plurality of imagers, the stream of image data presented as if from a single imager, the dynamic intelligent imager switch configured to:
forward a first set of image data to the processing device, the first set of data received from a first imager of the plurality of imagers, wherein the first imager is then a presently selected imager;
detect that a completed image frame is received in the first set of image data;
automatically change the presently selected imager from the first imager to a second imager of the plurality of imagers in response to detecting a completed image frame is received in the first set of image data; and
forward a second set of image data to the processing device, the second set of data received from the second imager, which is then the presently selected imager.

30. The data reader of claim 29, further comprising:
a main housing comprising a lower housing section including a horizontal window and an upper housing section including a vertical window, wherein the first imager has a field of view directed through the horizontal window to capture an image of the item from a first perspective as the item is passed through the view volume of the data reader and the second imager of the plurality of imagers has a field of view directed through the vertical window to capture an image of the item from a second perspective as the item is passed through the view volume of the data reader.

31. A data reader comprising:
a plurality of imagers operative to capture image data of an item passed through a view volume of the data reader;
a processing device configured to process image data to identify and decode an optical code within the image data; and
a dynamic intelligent imager switch comprising:
a plurality of imager interfaces coupled to the plurality of imagers;
a processor interface coupled to an imager interface of the processing device;
switching logic to forward, to the processor interface, image data received at a presently selected imager interface that comprises one of the plurality of imager interfaces; and
detection logic operative to detect a desired portion of an image frame in the image data received at a presently selected imager interface of the switching logic and forwarded to the processor interface, the detection logic further operative to automatically switch the presently selected imager interface from a first imager interface of the plurality of imager interfaces to a second imager interface of the plurality of imager interfaces, upon detecting the desired portion of an image frame,
wherein the dynamic intelligent imager switch couples the plurality of imagers to the imager interface of the processing device and provides to the processor a single stream of image data that includes multiple desired portions of image frames captured by multiple of the plurality of imagers, the stream of image data presented to the imager interface of the processing device as if the multiple desired portions of image frames are from a single imager.

32. The data reader of claim 31, wherein the desired portion of an image frame is a complete image frame.

33. The data reader of claim 31, wherein the processing device comprises only a single imager interface.
